(19) United States
(12) Patent Application Publication
(10) Pub. No.: US 2025/0123832 A1
(43) Pub. Date: Apr. 17, 2025

(54) SOFTWARE UPDATING SYSTEM, WORKING MACHINE, AND SOFTWARE UPDATING METHOD

(71) Applicant: KOMATSU LTD., Tokyo (JP)

(72) Inventors: Youhei CHIMURA, Tokyo (JP); Jun YAMANE, Tokyo (JP)

(21) Appl. No.: 18/685,279

(22) PCT Filed: Aug. 26, 2022
(86) PCT No.: PCT/JP2022/032230

§ 371 Date: Feb. 21, 2024

(30) Foreign Application Priority Data
Aug. 31, 2021 (JP) 2021-141277

(51) Int. Cl. G06F 8/65

(52) U.S. Cl. CPC G06F 8/65

(57) ABSTRACT

A reception unit receives data including first software for updating a first component, which is one of a plurality of components, and second software that is software for updating a second component, which is another one of the plurality of components, and for realizing a function associated with the first software, from a server. A storage unit stores received first software and second software. An update unit updates the first component and the second component based on the first software and the second software after the first software and the second software are stored in the storage unit.

### CROSS-REFERENCE TO RELATED APPLICATIONS

This application is a U.S. National stage application of International Application No. PCT/JP2022/032230, filed on Aug. 26, 2022. This U.S. National stage application claims priority under 35 U.S.C. § 119(a) to Japanese Patent Application No. 2021-141277, filed in Japan on Aug. 31, 2021, the entire contents of which are hereby incorporated herein by reference.

### BACKGROUND

The present disclosure relates to a software updating system, a work machine, and a software updating method.

Priority is claimed to Japanese Patent Application No. 2021-141277, filed on Aug. 31, 2021, the content of which is incorporated herein by reference.

### Background Information

A work machine is provided with a component for controlling the work machine or monitoring a state of the work machine. The component is composed of a microcomputer or the like and exhibits functions thereof by executing software. Therefore, the software of the component may be updated for the purpose of extending the functions of the component and the like. Japanese Unexamined Patent Application, First Publication No. 2017-41114 discloses a technique of updating software of a component of a work machine.

### SUMMARY

Incidentally, some functions implemented in the work machine are realized by a plurality of components cooperating with each other. In order to realize such functions in the work machine, it is necessary to update the software of each of the plurality of components.

Incidentally, the software to be installed in the work machine is received via a network. However, the work machine is not always in an environment where the work machine can be connected to the network, and may not be able to connect to the network for several days. Therefore, in a case where the plurality of components are updated using a procedure described in Japanese Unexamined Patent Application, First

Publication No. 2017-41114, there is a possibility that the work machine is disconnected from the network in a state in which some of the plurality of components are updated and the remaining components are not updated. In this case, the work machine will not be able to realize the functions that are realized by the plurality of components cooperating with each other until the work machine can connect to the network again and the remaining components are updated.

An object of the present disclosure is to provide a software updating system, a work machine, and a software updating method capable of increasing reliability of an update of a plurality of components in order to realize a function realized by the plurality of components cooperating with each other.

According to an aspect of the present disclosure, a software updating system is a software updating system for updating a plurality of components provided in a work machine, the software updating system including: a reception unit configured to receive data including first software used for updating a first component, which is one of the plurality of components, and second software that is software used for updating a second component, which is one of the plurality of components, and is for realizing a function associated with the first software, from a server; a storage unit configured to store the received first software and second software; and an update unit configured to update the first component and the second component based on the first software and the second software after the first software and the second software are stored in the storage unit.

According to the above aspect, the software updating system can increase reliability of the update of the plurality of components in order to realize the function realized by the plurality of components cooperating with each other.

### BRIEF DESCRIPTION OF DRAWINGS

FIG. 1 is a configuration view of a software updating system according to a first embodiment.

FIG. 2 is a perspective view showing an outer appearance of the work machine according to the first embodiment.

FIG. 3 is a diagram showing imaging ranges of a plurality of cameras provided in the work machine according to the first embodiment.

FIG. 4 is a diagram showing an internal configuration of a cab according to the first embodiment.

FIG. 5 is a schematic block diagram showing a hardware configuration of a control system of the work machine according to the first embodiment.

FIG. 6 is a block diagram showing a configuration of a gateway function controller according to the first embodiment.

FIG. 7 is a block diagram showing a configuration of a component management server according to the first embodiment.

FIG. 8 is a block diagram showing a configuration of a software management server according to the first embodiment.

FIG. 9 is a diagram showing an example of a software table according to the first embodiment.

FIG. 10 is a sequence diagram showing a method of updating software of a component in the software updating system according to the first embodiment.

FIG. 11 is a flowchart showing an item number confirmation process of the gateway function controller according to the first embodiment.

FIG. 12 is a flowchart showing a single software update process by the gateway function controller according to the first embodiment.

FIG. 13 is a flowchart showing a plurality of software update processes by the gateway function controller according to the first embodiment.

### DESCRIPTION OF EMBODIMENTS

### First Embodiment

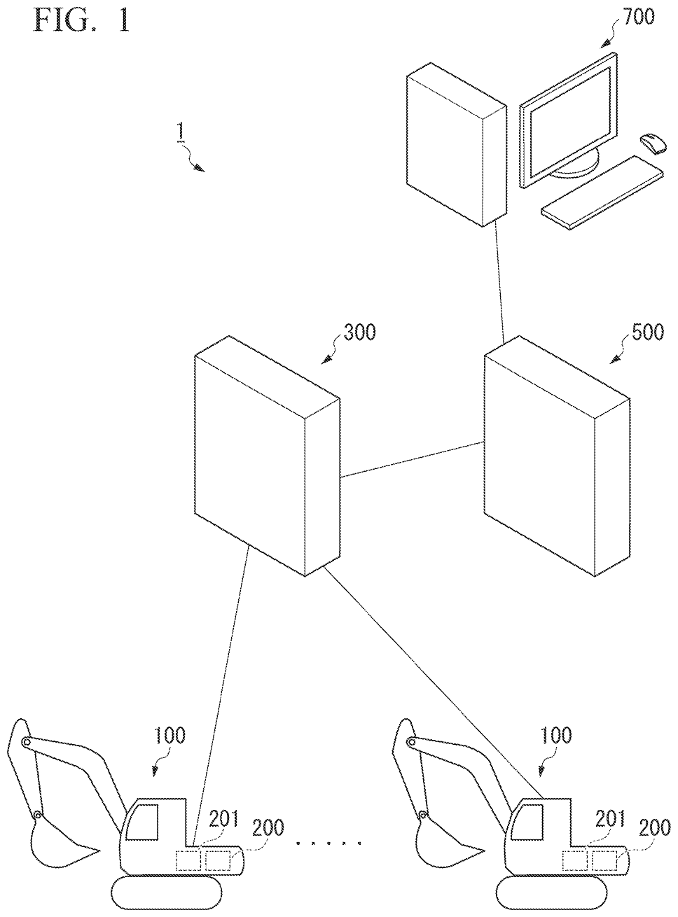

FIG. 1 is a configuration view of a software updating system 1 according to a first embodiment.

The software updating system 1 manages item numbers of software of components 200 included in a plurality of work machines 100. The software updating system 1 includes the plurality of work machines 100, a component management server 300, a software management server 500, and a developer terminal 700. The software is data used to realize functions of hardware. The software may include programs and setting data. In addition, the item number of the software is a unique identifier for identifying the software. The item number of the software is expressed, for example, by a plurality of numbers or a combination of alphabets.

Each work machine 100 includes a gateway function controller 201 and two or more components 200. The gateway function controller 201 is also an example of the components 200. The gateway function controller 201 is connected to an internal network and an external network of the work machine 100. The internal network is a network that connects the components 200 inside the work machine 100 to each other. The external network is a wide area network (WAN) that connects the work machine 100 and a device outside the work machine. Each component 200 exhibits a function of controlling the work machine 100 or monitoring a state of the work machine 100. Each component 200 and the gateway function controller 201 are connected to each other by the internal network of the work machine 100. Accordingly, some components 200 can receive calculation results of other components 200 via the internal network and can further perform a calculation. Although a hydraulic excavator is illustrated as the work machine 100 in FIG. 1, other work machines may be used, for example, a bulldozer, a dump truck, or a wheel loader.

The component management server 300 stores item numbers of the hardware and the software of the components 200 included in the plurality of work machines 100 and provides data for updating the software of the components 200 to the work machine 100. Specifically, the component management server 300 provides packet data including difference data between the software before the update and updated software of the component 200 to the work machine 100 via the external network. In addition, in a case where the plurality of components 200 need an update target to realize a predetermined function, the component management server 300 includes, in one package data, a plurality of pieces of difference data used for updating the plurality of components 200.

The software management server 500 stores, in association with the item number of the hardware of the component 200, a plurality of pieces of software having different item numbers applicable to the component 200 related to the item number. In addition, the software management server 500 generates difference data for updating the software and transmits the difference data to the component management server 300. In addition, the item number of the hardware is a unique identifier for identifying the component 200. The item number of the hardware is expressed by, for example, a plurality of numbers or a combination of alphabets.

The developer terminal 700 is a terminal operated by a developer of the software. The developer develops software by using the developer terminal 700 and transmits the developed software from the developer terminal 700 to the software management server 500. In a case where the developer creates pieces of software of a plurality of components 200 for realizing a predetermined function in cooperation, the developer transmits item number information indicating the item number of each component to which the software is applicable, and data of a plurality of pieces of software in association with each other to the software management server 500.

### <<Configuration of Work Machine 100>>

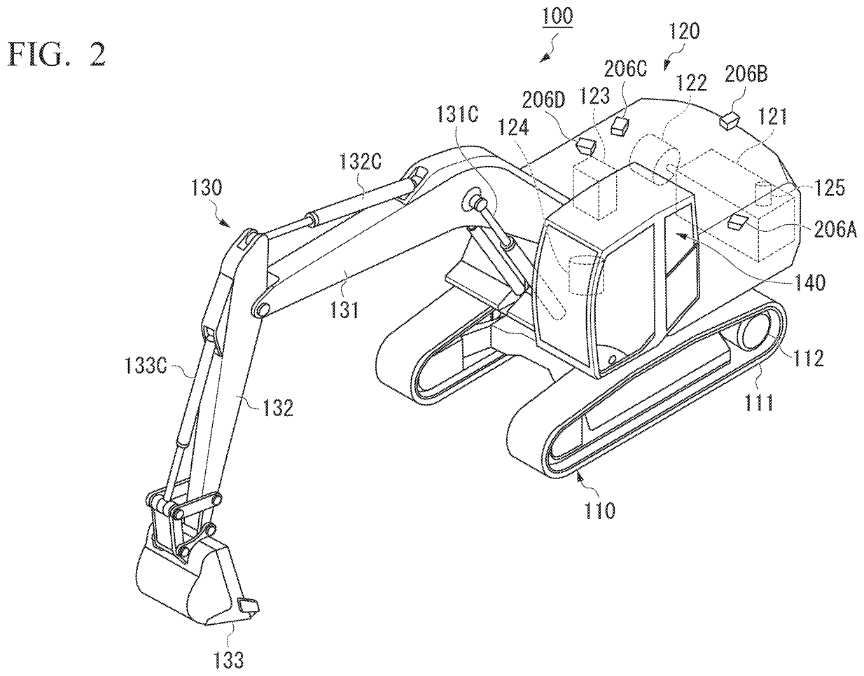

FIG. 2 is a perspective view showing an outer appearance of the work machine 100.

The work machine 100, which is a work machine, includes work equipment 130 that operates hydraulically, a swing body 120 that supports the work equipment 130, and an undercarriage 110 that supports the swing body 120.

The undercarriage 110 supports the work machine 100 so that the work machine 100 can travel. The undercarriage 110 includes two endless tracks 111 provided on left and right sides and two traveling motors 112 for respectively driving the endless tracks 111.

The swing body 120 is supported by the undercarriage 110 to be swingable around a swing center.

The work equipment 130 is driven by hydraulic pressure. The work equipment 130 is supported by a front portion of the swing body 120 so that the work equipment 130 can be driven in an up-down direction. A cab 140 is a space in which the operator boards and operates the work machine 100. The cab 140 is provided on a left front portion of the swing body 120.

Here, a portion of the swing body 120 to which the work equipment 130 is attached is referred to as a front portion. In addition, in the swing body 120, a portion on an opposite side, a portion on a left side, and a portion on a right side with respect to the front portion are referred to as a rear portion, a left portion, and a right portion.

### <<Configuration of Swing Body 120>>

The swing body 120 includes an engine 121, a hydraulic pump 122, a control valve 123, a swing motor 124, and a fuel injection device 125.

The engine 121 is a prime mover that drives the hydraulic pump 122. The hydraulic pump 122 is a variable displacement pump driven by the engine

121. The hydraulic pump 122 supplies hydraulic oil to each actuator (a boom cylinder 131C, an arm cylinder 132C, a bucket cylinder 133C, the traveling motor 112, and the swing motor 124) via the control valve 123.

The control valve 123 controls a flow rate of the hydraulic oil supplied from the hydraulic pump 122.

The swing motor 124 is driven by the hydraulic oil supplied from the hydraulic pump 122 via the control valve 123 to swing the swing body 120.

The fuel injection device 125 injects fuel into the engine 121.

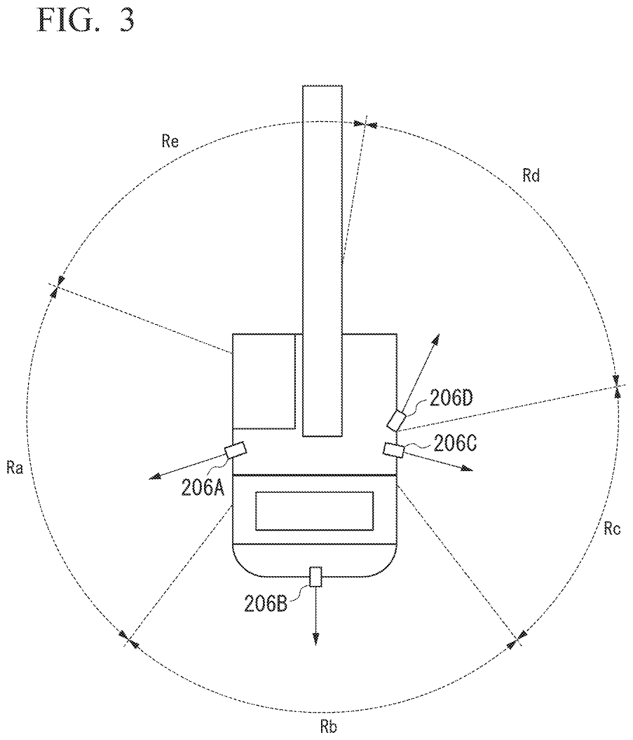

The swing body 120 is provided with a plurality of cameras 206 that capture images of surroundings of the work machine 100. FIG. 3 is a diagram showing imaging ranges of the plurality of cameras 206 provided in the work machine 100 according to the first embodiment.

Specifically, the swing body 120 is provided with a left rear camera 206A that captures an image of a left rear region Ra of the surroundings of the swing body 120, a rear camera 206B that captures an image of a rear region Rb of the surroundings of the swing body 120, a right rear camera 206C that captures an image of a right rear region Rc of the surroundings of the swing body 120, and a right front camera 206D that captures an image of a right front region Rd of the surroundings of the swing body 120. Here, the imaging ranges of the plurality of cameras 206 may partially overlap.

The imaging ranges of the plurality of cameras 206 cover a range of an entire periphery of the work machine 100 excluding a left front region Re that can be visually recognized from the cab 140. Here, the camera 206 according to the first embodiment captures images of regions on left rear, rear, right rear, and right front sides of the swing body 120, but are not limited thereto in another embodiment. For example, the number of the cameras 206 and the imaging ranges according to another embodiment may differ from the example shown in FIGS. 2 and 3.

### <<Configuration of Work Equipment 130>>

As shown in FIG. 2, the work equipment 130 includes a boom 131, an arm 132, a bucket 133, the boom cylinder 131C, the arm cylinder 132C, and the bucket cylinder 133C.

A proximal end portion of the boom 131 is attached to the swing body 120 via a boom pin.

The arm 132 connects the boom 131 and the bucket 133. A proximal end portion of the arm 132 is attached to a distal end portion of the boom 131 via an arm pin.

The bucket 133 includes blades for excavating earth or the like, and an accommodating portion that accommodates the excavated earth. A proximal end portion of the bucket 133 is attached to a distal end portion of the arm 132 via a bucket pin.

The boom cylinder 131C is a hydraulic cylinder for operating the boom 131. A proximal end portion of the boom cylinder 131C is attached to the swing body 120. A distal end portion of the boom cylinder 131C is attached to the boom 131.

The arm cylinder 132C is a hydraulic cylinder for driving the arm 132. A proximal end portion of the arm cylinder 132C is attached to the boom 131. A distal end portion of the arm cylinder 132C is attached to the arm 132.

The bucket cylinder 133C is a hydraulic cylinder for driving the bucket 133. A proximal end portion of the bucket cylinder 133C is attached to the arm 132. A distal end portion of the bucket cylinder 133C is attached to a link member connected to the bucket 133.

### <<Configuration of Cab 140>>

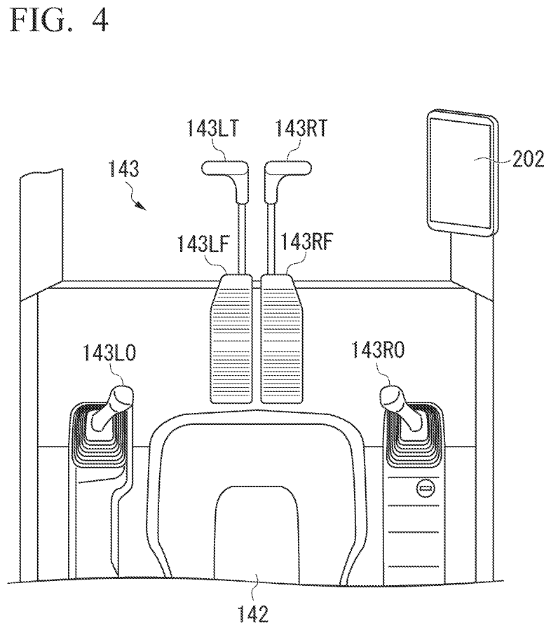

FIG. 4 is a diagram showing an internal configuration of the cab 140 according to the first embodiment.

In the cab 140, a driver seat 142, an operation device 143, and a monitor component 202 are provided.

The operation device 143 is a device for driving the undercarriage 110, the swing body 120, and the work equipment 130 by a manual operation of the operator. The operation device 143 includes a left operation lever 143LO, a right operation lever 143RO, a left foot pedal 143LF, a right foot pedal 143RF, a left traveling lever 143LT, and a right traveling lever 143RT.

The left operation lever 143LO is provided on a left side of the driver seat 142. The right operation lever 143RO is provided on a right side of the driver seat 142.

The left operation lever 143LO is an operation mechanism for causing the swing body 120 to perform a swinging operation and for causing the arm 132 to perform an excavating or dumping operation. Specifically, when the operator of the work machine 100 tilts the left operation lever 143LO forward, the arm 132 performs the dumping operation. In addition, when the operator of the work machine 100 tilts the left operation lever 143LO rearward, the arm 132 performs the excavating operation. In addition, when the operator of the work machine 100 tilts the left operation lever 143LO in a rightward direction, the swing body 120 swings rightward. In addition, when the operator of the work machine 100 tilts the left operation lever 143LO in a leftward direction, the swing body 120 swings leftward. In another embodiment, the swing body 120 may swing rightward or swing leftward in a case where the left operation lever 143LO is tilted in the front-rear direction, and the arm 132 may perform the excavating operation or the dumping operation in a case where the left operation lever 143LO is tilted in the left-right direction.

The right operation lever 143RO is an operation mechanism for causing the bucket 133 to perform an excavating or dumping operation and for causing the boom 131 to perform a raising or lowering operation. Specifically, when the operator of the work machine 100 tilts the right operation lever 143RO forward, a lowering operation of the boom 131 is performed. In addition, when the operator of the work machine 100 tilts the right operation lever 143RO rearward, the raising operation of the boom 131 is performed. In addition, when the operator of the work machine 100 tilts the right operation lever 143RO in the rightward direction, the dumping operation of the bucket 133 is performed. In addition, when the operator of the work machine 100 tilts the right operation lever 143RO in the leftward direction, the excavating operation of the bucket 133 is performed. In another embodiment, the bucket 133 may perform the dumping operation or the excavating operation in a case where the right operation lever 143RO is tilted in the front-rear direction, and the boom 131 may perform the raising operation or the lowering operation when the right operation lever 143RO is tilted in the left-right direction.

The left foot pedal 143LF is disposed on a left side of a floor surface in front of the driver seat 142. The right foot pedal 143RF is disposed on a right side of the floor surface in front of the driver seat 142. The left traveling lever 143LT is pivotally supported by the left foot pedal 143LF, and is configured such that inclination of the left traveling lever 143LT and pressing down of the left foot pedal 143LF are linked to each other. The right traveling lever 143RT is pivotally supported by the right foot pedal 143RF, and is configured such that inclination of the right traveling lever 143RT and pressing down of the right foot pedal 143RF are linked to each other.

The left foot pedal 143LF and the left traveling lever 143LT correspond to rotational drive of a left track shoe of the undercarriage 110. Specifically, when the operator of the work machine 100 tilts the left foot pedal 143LF or the left traveling lever 143LT forward, the left track shoe rotates in a forward movement direction. In addition, when the operator of the work machine 100 tilts the left foot pedal 143LF or the left traveling lever 143LT rearward, the left track shoe rotates in a backward movement direction.

The right foot pedal 143RF and the right traveling lever 143RT correspond to rotational drive of a right track shoe of the undercarriage 110. Specifically, when the operator of the work machine 100 tilts the right foot pedal 143RF or the right traveling lever 143RT forward, the right track shoe rotates in the forward movement direction. In addition, when the operator of the work machine 100 tilts the right foot pedal 143RF or the right traveling lever 143RT backward, the right track shoe rotates in the backward movement direction.

### <<Configuration of Control System>>

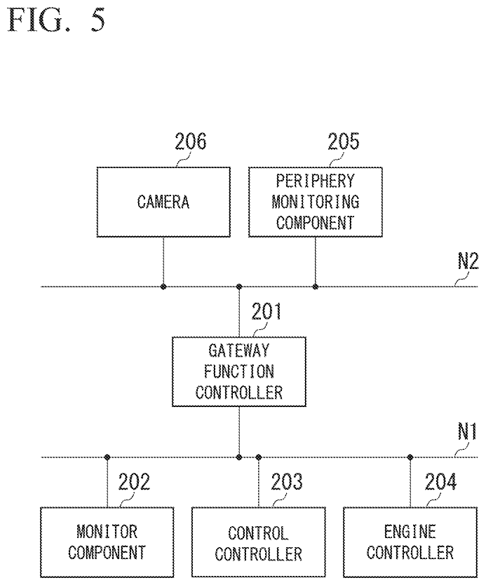

FIG. 5 is a schematic block diagram showing a hardware configuration of a control system of the work machine 100 according to the first embodiment.

The work machine 100 includes the gateway function controller 201, the monitor component 202, a control controller 203, an engine controller 204, and a periphery monitoring component 205. The gateway function controller 201, the monitor component 202, the control controller 203, the engine controller 204, the periphery monitoring component 205, and the camera 206 are connected to each other via an in-vehicle network. Specifically, the gateway function controller 201, the monitor component 202, the control controller 203, and the engine controller 204 are connected via a first network Nl such as a controller area network (CAN), and the gateway function controller 201, the camera 206, and the periphery monitoring component 205 are connected to each other via a second network N2 such as Ethernet (registered trademark).

The gateway function controller 201, the monitor component 202, the control controller 203, the engine controller 204, the periphery monitoring component 205, and the camera 206 are all examples of the components 200 provided in the work machine 100.

The gateway function controller 201 converts communication protocols of the first network N1 and the second network N2 to each other, and relays communication between the component 200 connected to the first network N1 and the component 200 connected to the second network N2.

The monitor component 202 is provided in the cab 140 and controls a display on a display.

The control controller 203 acquires various data associated with a hydraulic device that controls an operation of the work equipment 130 via a sensor (not shown), and outputs a control signal for controlling the hydraulic device according to an operation of the operation device 143. That is, the control controller 203 controls the drive of the boom cylinder 131C, the arm cylinder 132C, the bucket cylinder 133C, the traveling motor 112, the swing motor 124, or the like.

The engine controller 204 controls the engine 121 by acquiring various data associated with the engine 121 via a sensor (not shown) and instructing the fuel injection device 125 of a fuel injection amount.

The periphery monitoring component 205 generates an overhead image based on the image captured by the camera 206, and displays the overhead image on the monitor component 202.

### <<Configuration of Gateway Function Controller 201>>

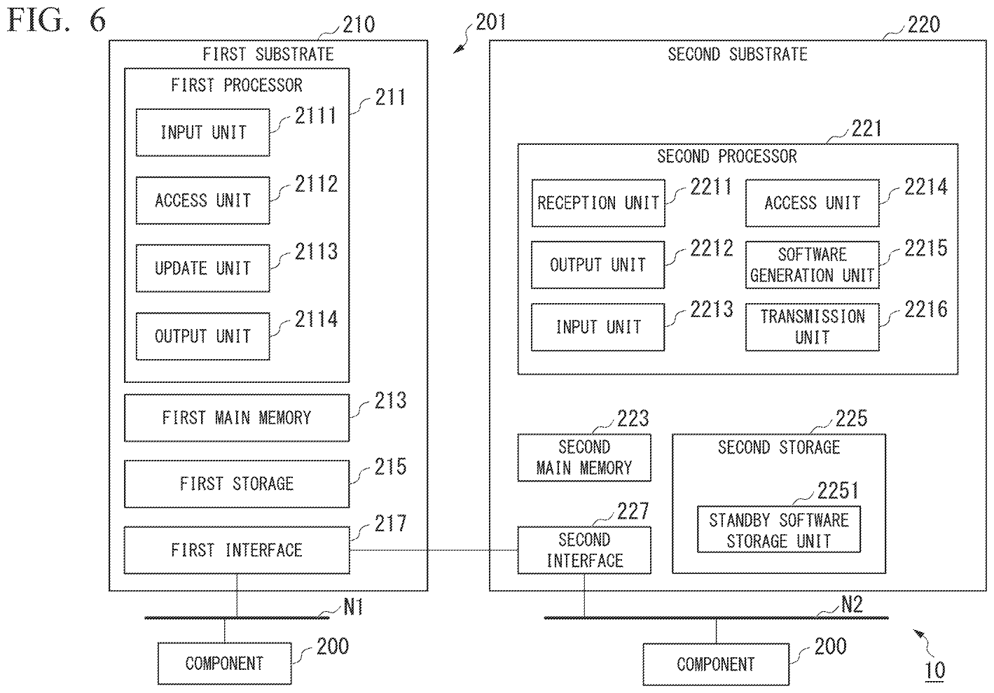

FIG. 6 is a block diagram showing a configuration of the gateway function controller 201 according to the first embodiment.

The gateway function controller 201 includes a first substrate 210 and a second substrate 220 that are physically separated.

The first substrate 210 includes a first processor 211, a first main memory 213, a first storage 215, and a first interface 217. The first processor 211 acquires a program from the first storage 215, deploys the program to the first main memory 213, and executes a predetermined process according to the program. In addition, the first storage 215 stores the same software including the program as two systems, active software and standby software. The active software is software that is used to exhibit functions of the software in normal times. The standby software is software that is used to recover the active software in case of an abnormality in the active software. That is, the first substrate 210 exhibits the functions thereof by executing the active software. In addition, for example, in a case where an abnormality occurs due to an update error or the like of the software and the active software cannot be executed, the first substrate 210 recovers the active software by copying the standby software into the active software, and executes the recovered active software. The first substrate 210 is an example of the component 200. The first interface 217 is connected to a plurality of the components 200 for controlling the work machine 100 via the first network N1 that is the internal network. Examples of the component 200 connected to the first substrate 210 include the monitor component 202, the control controller 203, and the engine controller 204. Basic operation control related to the operations of the work machine 100 is performed by the components 200 connected to the first network N1.

The second substrate 220 includes a second processor 221, a second main memory 223, a second storage 225, and a second interface 227. The second processor 221 acquires a program from the second storage 225, deploys the program to the second main memory 223, and executes a predetermined process according to the program. The second interface 227 is connected to a plurality of the components 200 for extending functions of the work machine 100 via the second network N2 that is the internal network. Examples of the component 200 connected to the second substrate 220 include the periphery monitoring component 205, the camera 206, a machine guidance component that displays and controls a guidance monitor for providing guidance for the operator on a positional relationship between a design surface of a construction site and the work machine 100 and the like, a payload component for measuring the amount of soil excavated by the work equipment 130, and a communication component that controls communication equipment for performing communication with an external server and acquires data from various sensors of the work machine. The components 200 connected to the second network N2 provide extended information for improving the functions of the work machine or the like to the work machine 100 and the operator. The second substrate 220 may be an example of the components of the work machine.

The first interface 217 and the second interface 227 are connected to communicate with each other. In addition, the first substrate 210 and the second substrate 220 store connection information indicating a route to each component 200 included in the work machine 100. The connection information may be, for example, a routing table. The connection information is updated by exchanging information between the first substrate 210 and the second substrate 220 whenever the component 200 is attached to or detached from the work machine 100.

In another embodiment, the first substrate 210 or the second substrate 220 may include a custom large scale integrated circuit (LSI), such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions realized by the first substrate 210 or the second substrate 220 may be realized by the integrated circuit.

Examples of the first storage 215 and the second storage 225 include magnetic disks, magneto-optical disks, optical disks, and semiconductor memories. The first storage 215 and the second storage 225 may be internal media directly connected to a bus line or external media connected to the gateway function controller 201 via the first interface 217 or a communication line. In at least one embodiment, the first storage 215 and the second storage 225 are non-transitory tangible storage media.

In addition, a calculation resource of the second substrate 220 is larger than a calculation resource of at least one component 200. In addition, it is preferable that the calculation resource of the second substrate 220 is larger than a calculation resource of the first substrate 210. The calculation resource is a resource used for calculation in computers. The calculation resource is a resource that provides a calculation time or storage capacity of a computer. Examples of the calculation resource include CPUs, main memories, and storages. It is preferable that a capacity of the second main memory 223 is larger than a capacity of the first main memory 213. In addition, it is preferable that a capacity of the second storage 225 is larger than a capacity of the first storage 215.

The first processor 211 functions as an input unit 2111, an access unit 2112, an update unit 2113, and an output unit 2114 by executing the program stored in the first storage 215.

The input unit 2111 receives a software acquisition instruction for the component 200 from the second substrate 220 as an input. In addition, the input unit 2111 receives a software update instruction for the component 200 from the second substrate 220 as an input.

The access unit 2112 acquires current software from the component 200 according to the software acquisition instruction received from the second substrate 220. The current software refers to software that is stored by the component 200 and executed for exhibiting a function when accessed by the access unit 2112. In addition, the access unit 2112 outputs the software to the component 200 according to the software update instruction received from the second substrate 220. The component 200 that has received the software rewrites the software.

The update unit 2113 acquires the active software from the first storage 215 according to the software update instruction received from the second substrate 220. In addition, the update unit 2113 rewrites the standby software and the active software according to the software update instruction received from the second substrate 220.

The output unit 2114 outputs the software acquired by the access unit 2112 or the update unit 2113 to the second substrate 220.

The second processor 221 functions as a reception unit 2211, an output unit 2212, an input unit 2213, an access unit 2214, a software generation unit 2215, and a transmission unit 2216 by executing the program stored in the second storage 225. In addition, a storage region of a standby software storage unit 2251 is secured in the second storage 225.

The reception unit 2211 receives a package file including the difference data of the software of the component 200 and a software update instruction for the component from the component management server 300. In addition, the reception unit 2211 receives an instruction to confirm the item number of the software of the component.

The output unit 2212 outputs the software acquisition instruction to the first substrate 210 in a case where the component 200 which is an update target is connected to the first substrate 210 or in a case where the component 200 which is an update target is the first substrate 210. In addition, the output unit 2212 outputs the software update instruction to the first substrate 210.

The input unit 2213 receives, as an input, the software of the component 200 which is an update target from the first substrate 210.

In a case where the component 200 which is an update target is connected to the second substrate 220, the access unit 2214 acquires software from the component 200. In addition, the access unit 2214 outputs software generated by the software generation unit 2215 to the component 200 which is an update target. The component 200 that has received the software rewrites the software. That is, the access unit 2214 is an example of an update unit that updates the component 200 based on the received software.

The software generation unit 2215 generates the updated software by applying the difference data received by the reception unit 2211 to the current software input to the input unit 2213 or the current software acquired by the access unit 2214. For example, the difference data holds a combination of an offset, which is the number of bits from the beginning of a file, and a changed value for each changed spot. In this case, the software generation unit 2215 identifies a corresponding portion of the current software based on the offset of the difference data, and rewrites a value before a change indicated by the difference data in the corresponding portion to the changed value. Accordingly, the software generation unit 2215 can generate the updated software from the current software and the difference data.

The transmission unit 2216 transmits a response to a request received by the reception unit 2211 to the component management server 300.

### <<Configuration of Component Management Server 300>>

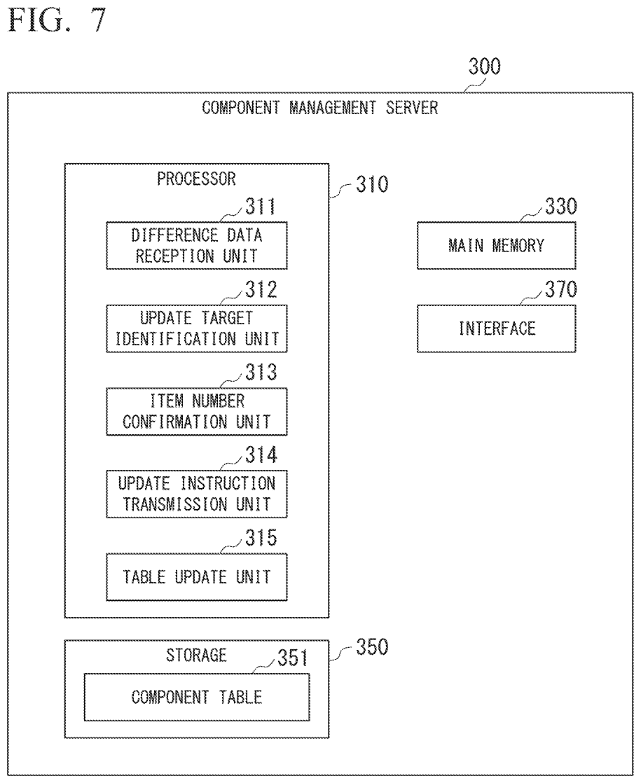

FIG. 7 is a block diagram showing a configuration of the component management server 300 according to the first embodiment.

The component management server 300 includes a processor 310, a main memory 330, a storage 350, and an interface 370. The processor 310 acquires a program from the storage 350, deploys the program to the main memory 330, and executes a predetermined process according to the program. A communication device (not shown) having a communication function via a wide area network is connected to the interface 370, and the interface 370 is connected to the second substrate 220 of the gateway function controller 201 and the software management server 500 to communicate therewith via the communication device.

The program stored in the storage 350 may be for realizing some of functions exhibited by the component management server 300. In addition, in another embodiment, the component management server 300 may include a custom LSI, such as a PLD, in addition to or instead of the above configuration. In this case, some or all of the functions realized by the component management server 300 may be realized by the integrated circuit.

Examples of the storage 350 include a magnetic disk, a magneto-optical disk, an optical disk, and a semiconductor memory. The storage 350 may be an internal medium directly connected to a bus line or an external medium connected to the component management server 300 via the interface 370 or a communication line. Alternatively, the program may not be stored in the storage 350 and may be distributed to the component management server 300 by a communication line so that the processor 310 executes the program. In at least one embodiment, the storage 350 is a non-transitory tangible storage medium.

The processor 310 includes a difference data reception unit 311, an update target identification unit 312, an item number confirmation unit 313, an update instruction transmission unit 314, and a table update unit 315 by executing the program stored in the storage 350. In addition, a storage region of a component table 351 is secured in the storage 350.

The component table 351 stores the item numbers of the hardware and the software of the component 200 included in each of the plurality of work machine 100. That is, the component table 351 stores a machine ID of the work machine 100, the hardware item number of the component, and a software item number in association with each other.

The difference data reception unit 311 receives the difference data of the software and a software item number which is an application target of the difference data from the software management server 500.

The update target identification unit 312 identifies, by reference to the component table 351, the component 200 related to the software item number received by the difference data reception unit 311 and the work machine 100 including the component 200.

The item number confirmation unit 313 transmits a confirmation request for the software item number of the component 200 which is an update target to the work machine 100 identified by the update target identification unit 312. The item number confirmation unit 313 receives a confirmation result of the software item number from the work machine 100.

The update instruction transmission unit 314 transmits the software update instruction to the work machine 100 in a case where the confirmation result received from the work machine 100 by the item number confirmation unit 313 matches the software item number received from the software management server 500 by the difference data reception unit 311. The software update instruction includes the difference data received by the difference data reception unit 311, a gateway script to be executed by the gateway function controller 201, and a component script to be executed by the component 200 which is an update target. The gateway script describes a procedure in which the gateway function controller 201 processes the difference data included in the update instruction. The component script describes a procedure for installing an updated program.

The table update unit 315 determines whether or not the software has been updated based on the confirmation result received from the work machine 100 by the item number confirmation unit 313 after the software update instruction. The table update unit 315 updates the component table 351 in a case where the table update unit 315 determines that the software has been updated.

### <<Configuration of Software Management Server 500>>

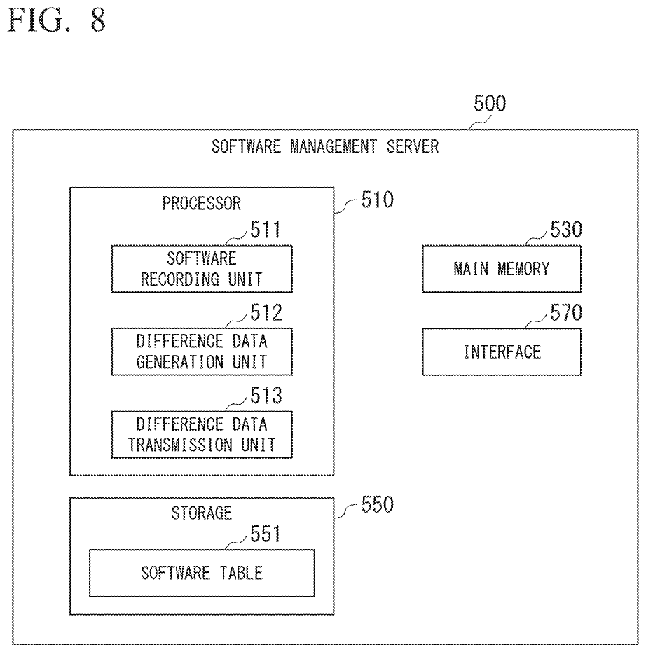

FIG. 8 is a block diagram showing a configuration of the software management server 500 according to the first embodiment.

The software management server 500 includes a processor 510, a main memory 530, a storage 550, and an interface 570. The processor 510 acquires a program from the storage 550, deploys the program to the main memory 530, and executes a predetermined process according to the program. The interface 570 is connected to the component management server 300 to communicate therewith.

The program stored in the storage 550 may be for realizing some of functions exhibited by the software management server 500. In addition, in another embodiment, the software management server 500 may include a custom LSI, such as a PLD, in addition to or instead of the above configuration. In this case, some or all of the functions realized by the software management server 500 may be realized by the integrated circuit.

Examples of the storage 550 include a magnetic disk, a magneto-optical disk, an optical disk, and a semiconductor memory. The storage 550 may be an internal medium directly connected to a bus line or an external medium connected to the software management server 500 via the interface 570 or a communication line. Alternatively, this program may be distributed to the software management server 500 by a communication line, and the processor 510 may execute the program. In at least one embodiment, the storage 550 is a non-transitory tangible storage medium.

The processor 510 includes a software recording unit 511, a difference data generation unit 512, and a difference data transmission unit 513 by executing programs stored in the storage 550. In addition, a storage region of a software table 551 is secured in the storage 550.

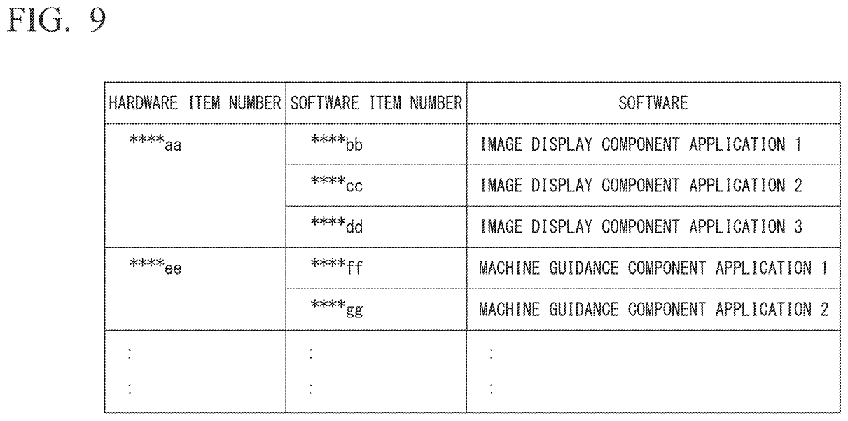

The software table 551 stores, in association with the hardware item number of the component 200, a plurality of kinds of software having different item numbers applicable to the component 200 related to the item number. That is, the software table 551 stores the hardware item number of the component, an entity of the software, and the software item number of the software in association with each other. FIG. 9 is a diagram showing an example of the software table according to the first embodiment. The software table 551 stores a hardware item number indicating an image display component, a software item number indicating an image display component application, and the entity of the software in association with each other. In an example shown in FIG. 9, the software table 551 stores a hardware item number indicating the machine guidance component, a software item number indicating a machine guidance component application, and the entity of the software in association with each other.

The software recording unit 511 receives, as inputs, the entity of the software, the item number of the software, and the hardware item number of the component 200 which is an application target of the software from an administrator of a server or the developer of the software, and records the inputs on the software table 551. The administrator or the developer operates the developer terminal 700 to transmit the entity of the software, the item number of the software, and the hardware item number of the component 200, which is an application target of the software, to the software management server 500. In addition, when the software recording unit 511 receives, as an input, item number information indicating hardware item numbers of a plurality of components 200 for realizing a predetermined function in cooperation with the developer terminal 700, the software recording unit 511 records the received item number information on the storage 550.

The difference data generation unit 512 generates difference data between the software newly recorded on the software table 551 and software of another item number applied to the hardware which is an application target of the software.

The difference data transmission unit 513 transmits the difference data generated by the difference data generation unit 512 and the software item number which is an application target of the difference data in association with each other to the component management server 300. In a case where the difference data transmission unit 513 receives the item number information of the plurality of components 200 from the developer terminal 700, the difference data transmission unit 513 also transmits the item number information to the component management server 300.

### <<Method of Updating Software>>

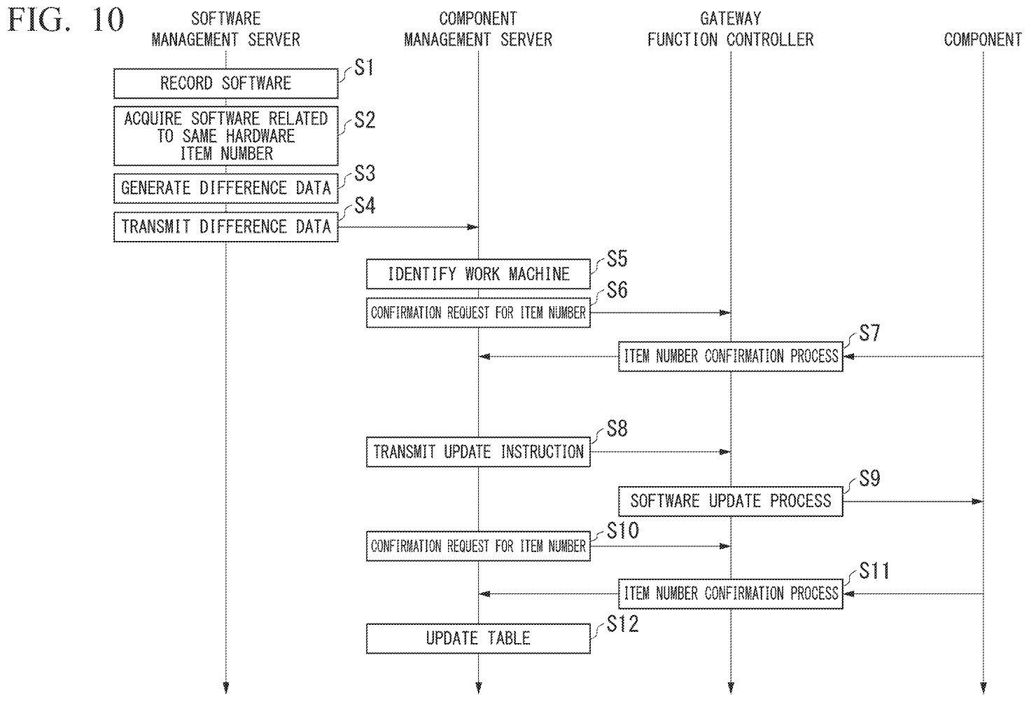

FIG. 10 is a sequence diagram showing a method of updating the software of the component 200 in the software updating system 1 according to the first embodiment.

When the developer updates the software of the component 200, the developer operates the developer terminal 700 and transmits the entity of the software, the item number of the software, and the hardware item number of the component 200, which is an application target of the software, in association with each other to the software management server 500. The software recording unit 511 of the software management server 500 records the received entity of the software, the software item number, and the hardware item number in association with each other on the software table 551 (step S1). In addition, the software item number received by the software recording unit 511 is an updated item number which is an updated software item number. Here, in a case where the item number information is received from the developer terminal 700, the software recording unit 511 records the received item number information on the storage 550.

The difference data generation unit 512 acquires the entity of the software and the software item number associated with the hardware item number received in step S1 from the software table 551 (step S2). The difference data generation unit 512 generates difference data for each software item number by calculating a difference between the software received in step S1 and each software acquired in step S2 (step S3). In a case where the software stored in the component 200 is always the latest, the difference data may be generated only for the latest software in the software acquired in step S2. The difference data transmission unit 513 transmits the difference data generated in step S3 in association with the hardware item number received in step S1, the updated item number received in step S1, and a target item number, which is the software item number acquired in step S2 to the component management server 300 (step S4). In a case where the item number information is received from the developer terminal 700 in step S1, the difference data transmission unit 513 also transmits the item number information to the component management server 300.

The difference data reception unit 311 of the component management server 300 receives the difference data, the software item number, and the hardware item number from the software management server 500 (step S4). The update target identification unit 312 identifies, by reference to the component table 351, the work machine 100 including the component 200 related to the received hardware item number (step S5). Alternatively, a plurality of work machines 100 including the component 200 related to the hardware item number may be identified. Next, the item number confirmation unit 313 transmits a confirmation request for the software item number of the component which is an update target to the gateway function controller 201 of the identified work machine 100 (step S6). That is, the hardware item number of the component 200 which is an update target is included in the confirmation request for the software item number.

The gateway function controller 201 receives the confirmation request for the software item number from the component management server 300 (step S6). The gateway function controller 201 executes an item number confirmation process for the component 200 and transmits the identified software item number to the component management server 300 (step S7). The software item number is written as a constant in the entity of the software, and is identified by, for example, executing an item number confirmation command possessed by the software. Details of the item number confirmation process by the gateway function controller 201 will be described below.

The item number confirmation unit 313 of the component management server 300 receives the software item number from the work machine 100 (step S7). In a case where the software item number received in step S7 and the target item number received in step S4 match each other, the update instruction transmission unit 314 transmits the software update instruction for the component which is an update target and the package file used for the update to the gateway function controller 201 of the work machine 100 (step S8). The software update instruction includes the difference data received in step S4, the gateway script to be executed by the gateway function controller 201, and the component script to be executed by the component 200 which is an update target. The gateway script includes the hardware item number of the component to which the difference data is applied.

In addition, in the component management server 300, in a case where the data received in step S4 includes the item number information indicating the hardware item numbers of the plurality of components 200, the update instruction transmission unit 314 generates, in addition to the difference data related to the plurality of components 200 indicated by the item number information, the gateway script, and the component script, a package file including hardware item number information of each component 200 required for realizing a function and update order information indicating an order in which the components 200 are updated.

The gateway function controller 201 receives the software update instruction and the package file from the component management server 300 (step S8). When the reception of the package file is completed, the gateway function controller 201 executes a software update process for the component 200 according to the gateway script included in the package file (step S9). The gateway script may describe that after key-off of the work machine 100, the individual components 200 are awakened by a function of a Wake-on-LAN or the like to execute the software update process. This is to prevent the component 200 from becoming non-functional due to an update while the work machine 100 is in operation. Alternatively, the gateway script may describe that after key-on, the software update process is executed when the operation of the work machine 100 is locked by a lock lever (a lever that cuts off flow passages of all hydraulic circuits for the work equipment, swing, and traveling}) of the work machine 100 (not shown). Details of the software update process by the gateway function controller 201 will be described below.

After a predetermined time after the difference data reception unit 311 of the component management server 300 transmits the update instruction in step S9, the item number confirmation unit 313 transmits a confirmation request for the software item number of the component which is an update target to the gateway function controller 201 of the work machine 100 to which the update instruction is transmitted (step S10). The predetermined time is sufficiently longer than a required calculation time for a process of applying the difference data to the software. Alternatively, in another embodiment, the gateway function controller 201 of the work machine 100 may transmit a completion notification after completion of the update to the component management server 300, and the item number confirmation unit 313 may transmit a confirmation request for the software item number of the component which is an update target to the gateway function controller 201 of the work machine 100 to which the completion notification has been transmitted.

The gateway function controller 201 receives a confirmation request for the software item number from the component management server 300. The gateway function controller 201 executes an item number confirmation process for the component 200 and transmits the identified software item number to the component management server 300 (step S11). Since the software item number is written as a constant in the entity of the software, when the software update process in step S9 is completed successfully, the software item number is also updated.

The item number confirmation unit 313 of the component management server 300 receives the software item number from the work machine 100 (step S11). In a case where the software item number received in step S11 and the updated item number received in step S4 match each other, the table update unit 315 updates the software item number of the component 200 stored in the component table 351 to the software item number received in step S11 (step S12).

In addition, the sequence diagram shown in FIG. 10 shows an example of the process and does not hinder the software from being updated by another process. For example, the software updating system 1 according to another embodiment may not perform the processes of step S6, step S7, step S10, step S11, and step S12. In addition, in another embodiment, the software item number may be stored in the main memory or storage (not shown) of the component 200. In this case, the gateway function controller 201 may transmit the item number confirmation request for the component 200 to the component 200 in steps S7 and S11, and the component 200 may acquire the software item number stored in the main memory or the storage and transmit the acquired software item number to the gateway function controller 201.

### <<Item Number Confirmation Process of Gateway Function Controller 201>>

Here, the operation of the gateway function controller 201 in the software update process will be described. When the reception unit 2211 of the second substrate 220 of the gateway function controller 201 receives the confirmation request for the software item number from the component management server 300 in step S6 or step S10, the gateway function controller 201 executes the item number confirmation process.

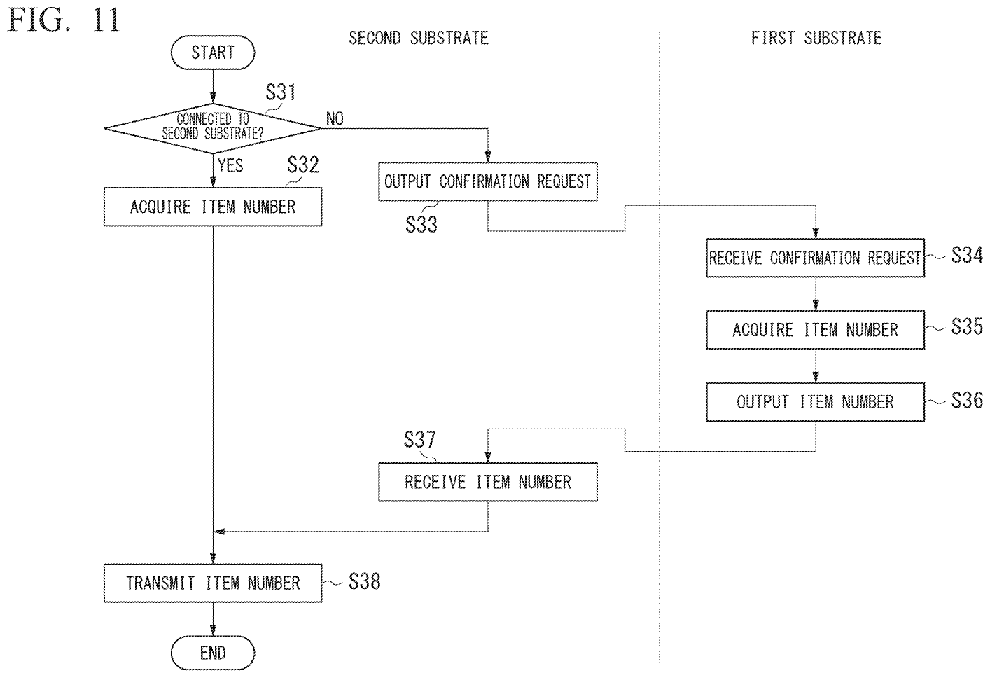

FIG. 11 is a flowchart showing the item number confirmation process of the gateway function controller 201 according to the first embodiment.

The reception unit 2211 determines whether or not the component 200 which is a confirmation target of the software item number, that is, the component 200 related to the hardware item number included in the confirmation request, is connected to the second substrate 220 (step S31). In a case where the component 200 which is a confirmation target is connected to the second substrate 220 (YES in step S31), the access unit 2214 acquires the software item number from the component 200 which is a confirmation target via the second network N2 (step S32).

On the other hand, in a case where the component 200 which is a confirmation target is not connected to the second substrate 220 (NO in step S31), the output unit 2212 outputs the confirmation request for the software item number to the first substrate 210 (step S33).

The input unit 2111 of the first substrate 210 receives the confirmation request for the software item number from the second substrate 220 (step S34). Next, the access unit 2112 acquires the software item number from the component 200 which is a confirmation target via the first network N1 (step S35). The output unit 2114 outputs the acquired software item number to the second substrate 220 (step S36).

The input unit 2213 of the second substrate 220 receives the software item number from the component 200 which is a confirmation target, from the first substrate 210 (step S37).

The transmission unit 2216 of the second substrate 220 transmits the software item number from the component 200 which is a confirmation target identified in step S32 or step S37, to the component management server 300 (step S38).

Accordingly, the gateway function controller 201 can provide notification of the software item number of the component 200 in response to the confirmation request of the component management server 300.

In addition, the flowchart shown in FIG. 11 shows an example of the process and does not hinder the item number from being confirmed by another process.

Alternatively, the gateway function controller 201 according to another embodiment may not perform the item number confirmation process. In addition, in another embodiment, the software item number may be stored in the main memory or storage (not shown) of the component 200. In this case, the second substrate 220 may transmit the item number confirmation request for the component 200 to the component 200 in steps S32 and S37, and the component 200 may acquire the software item number stored in the main memory or the storage and transmit the acquired software item number to the second substrate.

### <<Software Update Process of Gateway Function Controller 201>>

The reception unit 2211 of the second substrate 220 of the gateway function controller 201 receives the software update instruction and the package file from the component management server 300 in step S8. In a case where the reception of the package file is completed, the reception unit 2211 records the received package file on the second storage 225. The second storage 225 is an example of a storage unit that stores the package file. Then, the gateway function controller 201 executes the software update process by executing the gateway script included in the package file.

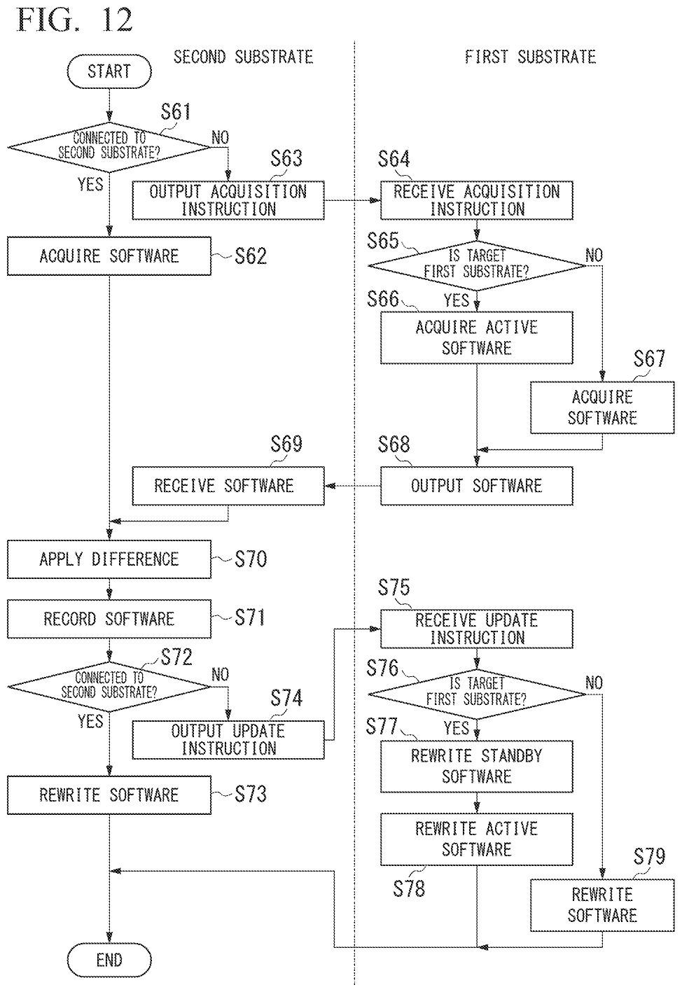

FIG. 12 is a flowchart showing a single software update process by the gateway function controller 201 according to the first embodiment. That is, an example shown in the flowchart shown in FIG. 12 represents a procedure in a case where the package file includes only data used for updating one component 200.

In order to communicate with the component 200 which is an update target of the software, that is, the component 200 related to the hardware item number described in the gateway script, the reception unit 2211 determines, by reference to the connection information, whether or not the component 200 is connected to the second substrate 220 (step S61). In a case where the component 200 which is an update target is connected to the second substrate 220 (YES in step S61), the access unit 2214 acquires the current software from the component 200 which is an update target via the second network N2 (step S62).

On the other hand, in a case where the component 200 which is an update target is connected to the first substrate 210 or in a case where the component 200 which is an update target is the first substrate 210 (NO in step S61), the output unit 2212 outputs a software acquisition instruction to the first substrate 210 (step S63).

The input unit 2111 of the first substrate 210 receives the software acquisition instruction from the second substrate 220 (step S64). The update unit 2113 determines whether or not the component 200 which is an update target is the first substrate 210 itself (step S65). In a case where the component 200 which is an update target is the first substrate 210 itself (YES in step S65), the update unit 2113 acquires the active software from the first storage 215 (step S66). On the other hand, in a case where the component 200 which is an update target is not the first substrate 210 itself (NO in step S65), the access unit 2112 acquires the current software from the component 200 which is an update target via the first network N1 (step S67). In addition, the component 200 may transmit information of the current software to the first substrate in a plurality of pieces. Accordingly, even the component 200 having a small calculation resource with which the current software cannot be transmitted to the first substrate by one transmission can transmit the information of the current software to the first substrate by transmitting the information in the plurality of pieces.

The output unit 2114 outputs the software acquired in step S66 or step S67 to the second substrate 220 (step S68).

The input unit 2213 of the second substrate 220 receives the software of the component 200 which is an update target from the first substrate 210 (step S69).

Then, the software generation unit 2215 generates the updated software by applying the difference data included in the package file received from the component management server 300 to the software acquired in step S62 or step S69 according to the gateway script (step S70). The software generation unit 2215 records the generated software in association with the hardware item number of the component 200 on the standby software storage unit (step S71). In order to transmit the generated software to the component 200 which is an update target, the software generation unit 2215 refers to the connection information and determines whether or not the component 200 which is an update target is connected to the second substrate 220 (step S72).

In a case where the component 200 which is an update target is connected to the second substrate 220 (YES in step S72), the access unit 2214 outputs the software generated in step S70 and the component script included in the package file to the component 200 which is an update target via the second network N2. Accordingly, the component 200 rewrites the software to be stored to the software generated in step S70 by executing the component script (step S73).

On the other hand, in a case where the component 200 which is an update target is connected to the first substrate 210 or in a case where the component 200 which is an update target is the first substrate 210 (NO in step S72), the output unit 2212 outputs a software update instruction to the first substrate 210 (step S74). The software update instruction includes the software generated in step S70 and the component script included in the update instruction.

The input unit 2111 of the first substrate 210 receives the software update instruction from the second substrate 220 (step S75). The update unit 2113 determines whether or not the component 200 which is an update target is the first substrate 210 itself (step S76). In a case where the component 200 which is an update target is the first substrate 210 itself (YES in step S76), the update unit 2113 rewrites the standby software stored in the first storage 215 to the software included in the update instruction (step S77). In a case where the rewriting of the standby software is completed, the update unit 2113 rewrites the active software stored in the first storage 215 to the software included in the update instruction (step S78).

On the other hand, in a case where the component 200 which is an update target is not the first substrate 210 itself (NO in step S76), the access unit 2112 outputs the software and the component script included in the package file to the component 200 which is an update target via the first network N1. Accordingly, the component 200 rewrites the software to be stored, to the software included in the package file by executing the component script (step S79).

Accordingly, the gateway function controller 201 can update the software of the component 200 based on the difference data.

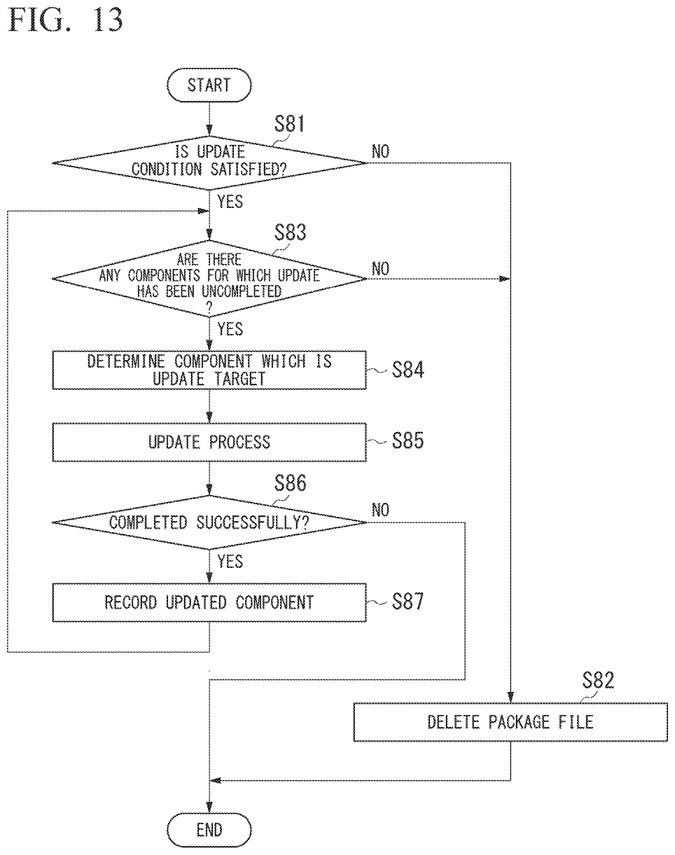

FIG. 13 is a flowchart showing a plurality of software update processes by the gateway function controller 201 according to the first embodiment. That is, an example shown in the flowchart shown in FIG. 13 represents a procedure in a case where the package file includes data used for updating a plurality of components 200 that realize functions related to each other.

The reception unit 2211 determines whether or not the hardware item number of each component 200 which is an update target satisfies an update condition, based on the hardware item number information included in the package file (step S81). The reception unit 2211 may determine the update condition based on the hardware item number of the component 200 acquired in step S7, or may receive the hardware item number from the component 200 again and determine the update condition. For example, the reception unit 2211 compares the hardware item number information included in the package file to the hardware item number of each component 200 which is an update target, and determines that the update condition is satisfied in a case where the hardware item number information and the hardware item number match.

In a case where at least one component 200 does not satisfy the update condition indicated by the hardware item number information (NO in step S81), the reception unit 2211 deletes the received package file (step S82), and does not perform updating of all the components 200 related to the update instruction. For example, even in a case where only one of three components 200 which are update targets does not satisfy the update condition and the remaining two components 200 satisfy the update condition, the gateway function controller 201 does not perform updating of all the three components 200.

On the other hand, in a case where all the components 200 satisfy the update condition (YES in step S81), the reception unit 2211 determines whether or not there are any components 200 for which the update has been uncompleted, among the plurality of components 200 indicated by the update order information included in the package file (step S83). For example, since the information on the component 200 for which the update has been completed is recorded on the second storage 225 in step S87 described below, in a case where there are any components 200 that are not recorded as components 200 for which the update has been completed among the plurality of components 200 indicated by the update order information, the reception unit 2211 determines that there are components 200 for which the update has been uncompleted. In a case where there are components 200 for which the update has been uncompleted (YES in step S83), the output unit 2212 determines the component 200 with an earliest update order as the component 200 which is an update target (step S84). Then, the component 200 which is an update target executes the processes of steps S61 to S70 shown in FIG. 12 and updates the software (step S85).

The access unit 2214 determines whether or not the update of the component 200 which is an update target has been successfully completed (step S86). For example, the access unit 2214 determines whether or not a notification indicating an abnormal end or interruption of the update has been received from the component 200. The access unit 2214 is an example of a detection unit that detects the interruption of the update of the component 200. In a case where the update of the component 200 which is an update target is not successfully completed (NO in step S86), the gateway function controller 201 interrupts the update process, does not update the component 200 with a later update order than the component 200 which is an update target determined in step S84, and ends the process.

On the other hand, in a case where the update has been successfully completed (YES in step S86), the completion of the update of the component 200 determined in step S84 is recorded on the second storage 225 (step S87). Accordingly, it is possible to identify the component 200 for which the update has been completed even in a case where the update process is interrupted due to a power failure. Then, the process returns to step S83, and the process moves to the next update of the component 200. In a case where it is determined that there is no component 200 for which the update has been uncompleted in step S83 (NO in step S83), the reception unit 2211 deletes the package file recorded on the second storage 225 (step S82) and ends the update process.

In addition, the flowchart shown in FIG. 13 shows an example of the process and does not hinder the item number from being confirmed by another process. For example, in another embodiment, the gateway function controller 201 may execute the update processes of the plurality of components 200 in parallel regardless of the update order information.

Here, the update of the plurality of components 200 will be described using a specific example. The periphery monitoring component 205 of the work machine 100 before the update has a function of generating an overhead image in which the work machine 100 is centered when viewed from above, based on the images captured by the camera 206. Contrary to this, the periphery monitoring component 205 can realize a function of detecting an obstacle existing within a predetermined distance from the work machine 100 by updating the software. In addition, the monitor component 202 can realize a function of marking the position of the detected obstacle on the overhead image due to an update of the software. In addition, the control controller 203 can realize a function of restricting the operation of the hydraulic device (for example, the traveling motor 112, the swing motor 124, the boom cylinder 131C, the arm cylinder 132C, and the bucket cylinder 133C) in a case where an obstacle is detected, by updating the software. That is, the software of the monitor component 202 and the control controller 203 is software related to the software of the periphery monitoring component 205. The software of the periphery monitoring component 205 is an example of first software, and the software of the monitor component 202 and the control controller 203 is an example of second software.

The component management server 300 receives the software of the periphery monitoring component 205, the monitor component 202, and the control controller 203 from the software management server 500 and generates difference data for each of the components. Then, the component management server 300 generates a package file including each difference data, the hardware item number information of each component 200, and update order information. In this case, an update order indicated by the update order information is, for example, an order of the periphery monitoring component 205, the control controller 203, and the monitor component 202.

The gateway function controller 201 of the work machine 100 receives the package file from the component management server 300. In a case where the communication is interrupted for some reason before the reception of the package file is completed, the work machine 100 does not update the software. Therefore, for example, in a case where the work machine 100 is started during the reception of the package file and moves to the outside of a communication range, it is possible to prevent a situation in which only some of the components 200 are updated and some remain in an old state.

On the other hand, in a case where the reception of the package file is completed, when the hardware item number of each component 200 does not satisfy the update condition indicated by the hardware item number information, the component 200 is not updated. Accordingly, it is possible to prevent a situation in which some of the components 200 are not updated and only some of the components 200 are updated.

In a case where the update condition indicated by the hardware item number information is satisfied, the gateway function controller 201 updates the components 200 in the order indicated by the update order information. Here, the update process may be interrupted for some reason in the middle of the update. For example, in a case where the work machine 100 is started during the update, the gateway function controller 201 interrupts an update operation and operates each component 200. In this case, the information of the component 200 for which the update has been completed in step S86 is recorded on the second storage 225. Therefore, by performing the processes from step S81 again, the reception unit 2211 can identify the component 200 for which the update is interrupted in steps S83 and S84 and can resume the update process. The reception unit 2211 is an example of a determination unit that determines the component 200 for which the update has been uncompleted, in a case where the interruption of the update is detected. In addition, since the package file has already been recorded on the second storage 225, the update process can be resumed even though the work machine 100 moves to the outside of the communication range when the update is resumed.

As described above, the software updating system 1 according to the first embodiment receives data including first software used for updating a first component and second software used for updating a second component from a server, stores the received data in a storage unit, and then updates the first component and the second component based on the first software and the second software. Accordingly, even in a case where the update of the plurality of components 200 is interrupted halfway, the software updating system 1 can resume the update, and can realize a function realized by the plurality of components 200 cooperating with each other. In particular, in a case where a function realized by the second software uses a calculation result by a function realized by the first software, the software updating system 1 according to the first embodiment can prevent a situation in which the function of the second software cannot be used without being updated by the first software.

### Other Embodiments

The embodiments have been described above in detail with reference to the drawings; however, the specific configurations are not limited to the above-described configurations, and various design changes or the like can be made. That is, in another embodiment, the order of the above-described processes may be appropriately changed.

In addition, some of the processes may be performed in parallel. The gateway function controller 201 according to the first embodiment generates software for all the components 200 of the work machine 100 in the second substrate 220 mounted on the work machine 100. On the other hand, in another embodiment, in a case where the component 200 having a sufficient calculation resource exists, the component 200 may autonomously generate new software from the difference data and autonomously update its own software. In another embodiment, the component management server 300 may transmit a package file including the new software itself used for the update instead of the difference data to the gateway function controller 201. In this case, for example, the software management server 500 transmits the hardware item number received in step S1, the entity of the software, the updated item number, and the target item number which is the software item number instead of the processes of steps S2 to S4 in the sequence diagram shown in FIG. 10 in association with each other to the component management server 300. In addition, the gateway function controller 201 records the new software used for the update received from the component management server 300 in association with the hardware item number of the component 200 instead of the processes of steps S61 to S71 shown in FIG. 12, on the standby software storage unit. The update instruction includes the new software used for the update, the gateway script to be executed by the gateway function controller 201, and the component script to be executed by the component 200 which is an update target. The gateway script describes a procedure for processing the new software.

The gateway function controller 201 according to the first embodiment includes the first substrate 210 and the second substrate 220 that are physically separated from each other. Contrary to this, the gateway function controller 201 according to another embodiment may be implemented on one substrate. In addition, in the gateway function controller 201 according to another embodiment, one substrate may include two processors. In addition, in another embodiment, the gateway function controller 201 may include three or more substrates. In addition, in another embodiment, roles of a plurality of substrates included in the gateway function controller 201 may be different from those in the above-described embodiments.

In addition, in another embodiment, the software management server 500 and the component management server 300 may be realized by one device instead of being separate entities.

According to the above aspect, the software updating system can increase reliability of the update of the plurality of components in order to realize the function realized by the plurality of components cooperating with each other.

1. A software updating system for updating a plurality of components provided in a work machine, the software updating system comprising:
a reception unit configured to receive data including first software for updating a first component, which is one of the plurality of components, and second software that is software for updating a second component, which is another one of the plurality of components, and for realizing a function associated with the first software, from a server;
a storage unit configured to store the received first software and second software; and
an update unit configured to update the first component and the second component based on the first software and the second software after the first software and the second software are stored in the storage unit.

2. The software updating system according to claim 1, wherein
the first component includes a periphery monitoring component that monitors a periphery using an imaging device provided in the work machine,
the second component includes a monitor component that performs a display control of a monitor provided in the work machine and a hydraulic component that performs a hydraulic control of a hydraulic device provided in the work machine,
the first software includes software for realizing the function of detecting an obstacle in a periphery of the work machine using the imaging device,
the second software includes software of the monitor component for displaying a display related to detection of the obstacle by the first software on the monitor, and software of the hydraulic component for controlling an output of the hydraulic device when the obstacle is detected by the first software, and
the update unit enables functions of the periphery monitoring component, the monitor component, and the hydraulic component associated with the function of detecting the obstacle, based on the first software and the second software.

3. The software updating system according to claim 1, wherein
the data includes update order information indicating an update order of the plurality of components, and
the update unit updates the plurality of components in an order indicated by the update order information.

4. The software updating system according to claim 3, wherein
when a component fails to update among the plurality of components, the update unit does not update a component indicated to be updated after the component in the update order information.

5. The software updating system according to claim 1, wherein
the update unit updates the second component using the second software after the update of the first component by the first software is completed.

6. The software updating system according to claim 2, wherein
the update unit updates the monitor component last among the plurality of components.

7. The software updating system according to claim 1, further comprising
a detection unit configured to detect an interruption of the update of the first component and the first second component based on the first software and the second software; and
a determination unit that determines a component among the first component and the second component for which the update has been uncompleted upon detecting the interruption of the update,
when the update of the component for which the update is determined to be uncompleted by the determination unit becomes resumable, the update unit updates the component for which the update is determined to be uncompleted by the determination unit based on the first software or the second software stored in the storage unit.

8. The software updating system according to claim 1, wherein
the data includes item number information indicating a condition of item numbers of the first component and the second component that are updatable by the first software and the second software, and
the update unit updates the first component and the second component in a case when the item numbers of the first component and the second component satisfy the condition indicated by the item number information.

9. A work machine comprising:
a vehicle body;
work equipment attached to the vehicle body;
the plurality of components including the first component and the second component; and
the software updating system according to claim 1.

10. A software updating method of updating a plurality of components provided in a work machine, the method comprising:
a step of causing a computer to receive data including first software ued for updating a first component, which is one of the plurality of components, and second software that is software for updating a second component, which is another one of the plurality of components, and for realizing a function associated with the first software, from a server;
a step of causing the computer to store the received first software and second software; and
a step of causing the computer to update the first component and the second component based on the first software and the second software after the first software and the second software are stored.
